(19) United States
(12) Patent Application Publication
(10) Pub. No.: US 2011/0264472 A1
(43) Pub. Date: Oct. 27, 2011

(54) Deductible shield

(75) Inventor: Felix Mostelac, Miami Beach, FL (US)

(73) Assignee: Felix Mostelac, Miami Beach, FL (US)

(21) Appl. No.: 12/799,443

(22) Filed: Apr. 26, 2010

(51) Int. Cl. G06Q 40/00; G06Q 50/00

(52) U.S. Cl. 705/4

(57) ABSTRACT

The Deductible Shield auto insurance deductible discount certificate program policy will cover a customers automobile deductible fee issued by their insurance provider for a year in case of an accident, no matter how many incidents said customer would have within the pre-paid yearly timeframe. If a customer has an automobile incident during the yearly term of agreement with The Deductible Shield, the customer will be given a list of participating licensed auto body repair shops in their area where they can go and have their vehicle repaired according to the terms provided by their original automobile insurance provider. After the original automobile insurance provider agrees to make the necessary repairs, The Deductible Shield customer will then provide the automobile body repair shop their proof of their The Deductible Shield account number and therefore the participating automobile body repair shop will waive the original automobile insurance providers automobile deductible fee.

### FIELD OF THE INVENTION

The present invention relates to providing automobile insurance policyholders a legal means to cover the costs of paying the automobile insurance deductible fee and, more particularly, to provide a business method wherein the automobile insurance policy holder will not have to pay an auto insurance deductible fee in the case of an automobile accident.

### BACKGROUND OF THE INVENTION

Since the invention of the automobile and the subsequent need to provide automobile operators with automobile insurance in order to protect the automobile owner against losses involving the damage to the automobile. Auto insurance provides protection from losses resulting from owning and operating an auto. The insurance covers losses to the insured's property and losses for which the insured is liable as a result of owning or operating an auto. Auto insurance has always had two payments that are required of them by said automobile collision insurer, insurance payment and an automobile deductible in case of an accident resulting in the damage of the vehicle. The auto insurance payment is a required monthly payment that is to be made by an automobile owner to the automobile insurance company in order to provide the service of having an automobile insurance policy that will cover the expenses associated with automobiles in case of an accident and/or collision resulting in damage to the automobile. An auto insurance deductible is a specified amount of money that you agree to pay your insurance company if you file a claim for damages before your policy will pay the claim in order to have the damaged vehicle repaired. The deductible amount is usually subtracted from the total amount of your claim and then you are given the remaining amount to cover your damages. The expansion of the automobile as a mass-produced means of preferred travel has brought with it the great potential for destruction of lives and property. In response to this, both the state and federal governments require mandatory auto insurance coverage. The insurance industry, which had already developed according to a system of tort law, has been applied to automobile insurance laws. And those laws have evolved into an enormous political and economic hydra that politicians and lawyers constantly critique and reform. Currently, auto insurance is the only example of something that Americans are required by law to buy (assuming they own cars), but it is provided exclusively by private industry on a for-profit basis. In the case concerning the payment of the automobile deductible lies the problem in which this method of business has solved. For years it has been the standard practice of the auto insurance industry to charge their customers an automobile deductible fee in the case of any damage with regards to the insured vehicle. This fee can range anywhere between five hundred US dollars and two-thousand five hundred US dollars depending on the terms of the automobile insurance policy and the extent of the damages to the automobile. Herein lies the problem with the auto insurance deductible fee, every time that the insured automobile is damaged, this fee is assessed no matter how major nor minor the extent of the damage is. Furthermore, the auto insurance industry has effectively dismissed the idea of waiving this deductible fee, citing that it is illegal under US tort law that this fee can not be waived even though no such law nor stipulation within US insurance tort law does not exist. Evidence of this can be read within an inquiry presented to the State of New York Insurance Department wherein the question was presented: ‘Would the discount certificate program proposed constitute the doing of an insurance business, for which licensing is required?’ The State of New York Insurance Department replied: ‘Yes, the discount certificate program would constitute the doing of an insurance business, for which licensing is required.’ Furthermore, the NY Office of General Counsel issued an opinion relating this waiver of auto insurance deductible discount certificate program on Apr. 2, 2007 by acknowledging that automobile insurance can be legally waived as long as the insured is protected under the current state anti-steering law. The Deductible Shield is an innovative method of legally obtaining this discount certificate for automobile deductible insurance by providing the customer with coverage that would cover the customers automobile deductible fee by paying a one time yearly fee to The Deductible Shield. The Deductible Shield auto insurance deductible discount certificate program policy will cover a said customers vehicle deductible fee for a year in case of an accident no matter how many incidents said customer would have within the pre-paid yearly timeframe.

There are no other solutions in existence to this problem.

would be advantageous to provide an automobile insurance customer the ability to waive the original automobile insurance providers automobile deductible fee.

It would also be advantageous to provide some form of protection for the automobile insurance customer from having to pay the exuberate costs of having to pay an automobile insurance out of pocket deductible fee every time that the customer has an automobile related incident.

It would further be advantageous to provide a means for an automobile insurance customer to be able to pay the immense out of pocket expense that is attributed to the original automobile insurance deductible fee. Providing this service will allow an automobile insurer to maintain a properly working vehicle regardless of the amounts of incidents that the consumer accrues.

### SUMMARY OF THE INVENTION

In accordance with the present invention, there is provided that The Deductible Shield is an innovative method of legally obtaining this discount certificate for automobile deductible insurance by providing the customer with coverage that would cover the customers automobile deductible fee by paying a one time yearly fee to The Deductible Shield in exchange for providing this service. The Deductible Shield auto insurance deductible discount certificate program policy will cover a said customers vehicle deductible fee for a year in case of an accident, no matter how many incidents said customer would have within the pre-paid yearly timeframe. Said customer will pre-pay a yearly fee to The Deductible Shield, the customer will have to provide valid proof of insurance, license, a proper VIN (Vehicle Identification Number) and provide the costs of the auto deductible fee issued by the original automobile insurance provider. After the yearly fee is paid to The Deductible Shield in exchange for this service, the customer will receive a proof coverage card containing a personal account number provided by The Deductible Shield. If a customer has an incident during the yearly term of agreement with The Deductible Shield, the customer will be given a list of participating licensed auto body repair shops in their area where they can go and have their vehicle repaired according to the terms provided by their original automobile insurance provider. After the original automobile insurance provider agrees to make the necessary repairs, The Deductible Shield customer will then provide the automobile body repair shop their proof of The Deductible Shield auto insurance deductible discount certificate program and therefore the participating automobile body repair shop will waive the original automobile insurance providers automobile deductible fee.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of an insurance customer with a valid driver's license, valid proof of automobile insurance and valid vehicle registration. the customer is directed to show valid proof of all three of these legal requirements before obtaining the opportunity to obtain the deductible shield;

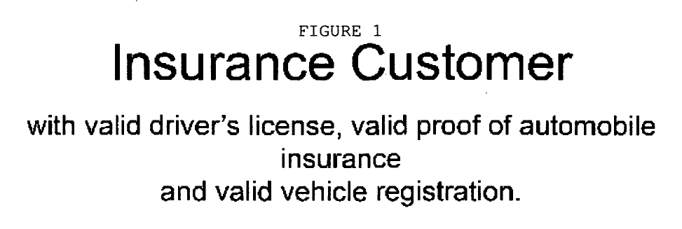

FIG. 2 is a top sectional view of an event after an accident or incident the customer must first contact their original insurance provider and claim the damages before being able to use the deductible shield deductible certificate program. after the incident claim is officially filed with the original automobile insurance provider, the original insurance provider will then appraise and issue the customer with a deductible fee in order to approve the customers coverage;

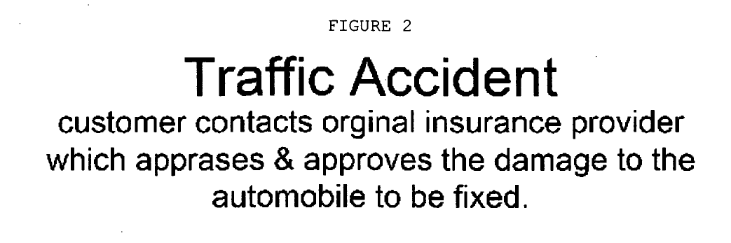

FIG. 3 is a front plan view of an after the original automobile insurance provider approves the damages and issues their deductible fee in order for the customer to fix their vehicle. the deductible shield deductible certificate program will then offer the deductible shield member a wide variety of automobile repair shops that honor the deductible shield automobile deductible certificate program and will therefore agree to allow the deductible shield to cover the expense of the original insurance providers deductible fee; and

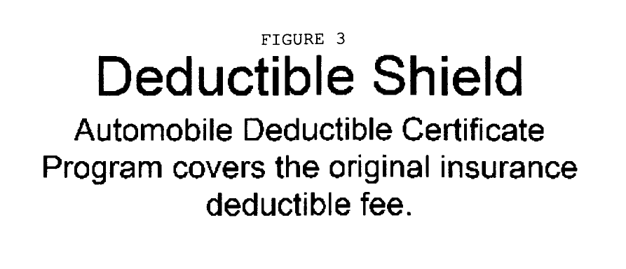

FIG. 4 is a bottom plan view of the deductible shield covering the expense of the original insurance providers automobile deductible fee. therefore allowing the deductible shield member to repair their vehicle with a certified licensed automobile repair professional without having to pay the expense of the original insurance providers automobile deductible fee.

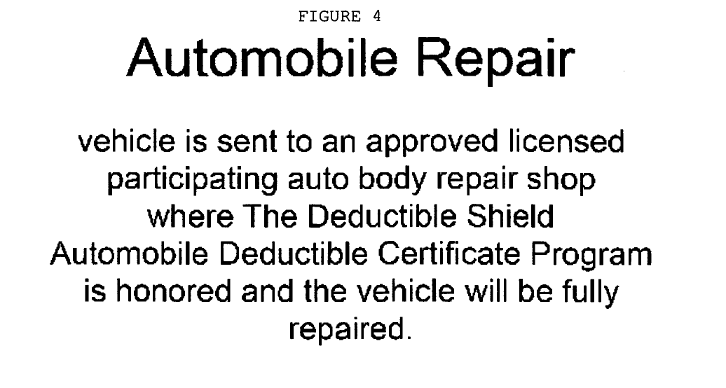

For purposes of clarity and brevity, like elements and components will bear the same designations and numbering throughout the Figures.

### DESCRIPTION OF THE PREFERRED EMBODIMENT

The Deductible Shield auto insurance deductible discount certificate program policy will cover a said customers vehicle deductible fee for a year in case of an accident, no matter how many incidents said customer would have within the pre-paid yearly timeframe. Said customer will pre-pay a yearly fee to The Deductible Shield in exchange for this service, the customer will provide valid proof of insurance, license, a proper VIN (Vehicle Identification Number) and provide the costs of the automobile deductible fee issued by the original automobile insurance provider in order to fulfill all of the necessary Insurance Requirements 10. After the fee is paid, the customer will receive a proof of coverage card containing a personal account number provided by The Deductible Shield. If a customer has a Traffic Incident 12 during the yearly term of agreement with The Deductible Shield, the customer will be given a list of participating licensed auto body repair shops in their area that honor The Deductible Shield automobile insurance deductible discount certificate program where they can go and have their vehicle repaired according to the terms provided by their original automobile insurance provider in order to use their The Deductible Shield Coverage 14. After the original automobile insurance provider agrees to make the necessary repairs, The Deductible Shield customer will then provide the Automobile Repair 16 shop their proof of The Deductible Shield auto insurance deductible discount certificate program and therefore the participating automobile body repair shop will waive the original automobile insurance providers automobile deductible fee.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A deductible shield for a business method for providing auto insurers deductible coverage, comprising:
means for confirming that an automobile insurance customer has the necessary legal requirements of a valid, driver's license, a valid proof of original automobile insurance and a valid vehicle registration in order for the automobile insurance customer to be able qualify to purchase the deductible shield automobile deductible certificate program;
means for providing the automobile insurance customer a prerequisite number of steps that must be followed following any incident before being able to use the deductible shield automobile deductible certificate program. these steps require the customer to contact the original insurance provider which will appraise and approve the repair costs of the customers vehicle. after the original insurance provider establishes the cost of the customers automobile deductible fee then the deductible shield automobile deductible certificate program can be used, vertically connected to said means for confirming that an automobile insurance customer has the necessary legal requirements of a valid, driver's license, a valid proof of original automobile insurance and a valid vehicle registration in order for the automobile insurance customer to be able qualify to purchase the deductible shield automobile deductible certificate program;
means for providing the deductible shield automobile deductible certificate program customer a list of participating licensed auto body repair shops in order fully repair the customers vehicle and allow the deductible shield automobile deductible certificate program to absorb the cost of the customers original automobile insurance's deductible fee, vertically connected to said means for providing the automobile insurance customer a prerequisite number of steps that must be followed following any incident before being able to use the deductible shield automobile deductible certificate program. these steps require the customer to contact the original insurance provider which will appraise and approve the repair costs of the customers vehicle. after the original insurance provider establishes the cost of the customers automobile deductible fee then the deductible shield automobile deductible certificate program can be used; and
means for providing the deductible shield automobile deductible certificate program customer the guarantee that the deductible shield will verify that the vehicle has been fully repaired by a participating licensed auto body repair shop that honors the deductible shield automobile deductible certificate program. once the repairs have been fully verified then the repaired vehicle will be released to the customer, vertically connected to said means for providing the deductible shield automobile deductible certificate program customer a list of participating licensed auto body repair shops in order fully repair the customers vehicle and allow the deductible shield automobile deductible certificate program to absorb the cost of the customers original automobile insurance's deductible fee.

2. The deductible shield in accordance with claim 1, wherein said means for confirming that an automobile insurance customer has the necessary legal requirements of a valid, driver's license, a valid proof of original automobile insurance and a valid vehicle registration in order for the automobile insurance customer to be able qualify to purchase the deductible shield automobile deductible certificate program comprises an insurance requirements insurance requirements.

3. The deductible shield in accordance with claim 1, wherein said means for providing the automobile insurance customer a prerequisite number of steps that must be followed following any incident before being able to use the deductible shield automobile deductible certificate program. these steps require the customer to contact the original insurance provider which will appraise and approve the repair costs of the customers vehicle. after the original insurance provider establishes the cost of the customers automobile deductible fee then the deductible shield automobile deductible certificate program can be used comprises a traffic incident traffic incident.

4. The deductible shield in accordance with claim 1, wherein said means for providing the deductible shield automobile deductible certificate program customer a list of participating licensed auto body repair shops in order fully repair the customers vehicle and allow the deductible shield automobile deductible certificate program to absorb the cost of the customers original automobile insurance's deductible fee comprises the deductible shield coverage the deductible shield coverage.

5. The deductible shield in accordance with claim 1, wherein said means for providing the deductible shield automobile deductible certificate program customer the guarantee that the deductible shield will verify that the vehicle has been fully repaired by a participating licensed auto body repair shop that honors the deductible shield automobile deductible certificate program. once the repairs have been fully verified then the repaired vehicle will be released to the customer comprises an automobile repair automobile repair.

6. A deductible shield for a business method for providing auto insurers deductible coverage, comprising:
an insurance requirements insurance requirements, for confirming that an automobile insurance customer has the necessary legal requirements of a valid, driver's license, a valid proof of original automobile insurance and a valid vehicle registration in order for the automobile insurance customer to be able qualify to purchase the deductible shield automobile deductible certificate program;
a traffic incident traffic incident, for providing the automobile insurance customer a prerequisite number of steps that must be followed following any incident before being able to use the deductible shield automobile deductible certificate program. these steps require the customer to contact the original insurance provider which will appraise and approve the repair costs of the customers vehicle. after the original insurance provider establishes the cost of the customers automobile deductible fee then the deductible shield automobile deductible certificate program can be used, vertically connected to said Insurance Requirements;
the deductible shield coverage the deductible shield coverage, for providing the deductible shield automobile deductible certificate program customer a list of participating licensed auto body repair shops in order fully repair the customers vehicle and allow the deductible shield automobile deductible certificate program to absorb the cost of the customers original automobile insurance's deductible fee, vertically connected to said Traffic Incident; and
an automobile repair automobile repair, for providing the deductible shield automobile deductible certificate program customer the guarantee that the deductible shield will verify that the vehicle has been fully repaired by a participating licensed auto body repair shop that honors the deductible shield automobile deductible certificate program. once the repairs have been fully verified then the repaired vehicle will be released to the customer, vertically connected to said The Deductible Shield Coverage.

7. A deductible shield for a business method for providing auto insurers deductible coverage, comprising:
an insurance requirements insurance requirements, for confirming that an automobile insurance customer has the necessary legal requirements of a valid, driver's license, a valid proof of original automobile insurance and a valid vehicle registration in order for the automobile insurance customer to be able qualify to purchase the deductible shield automobile deductible certificate program;
a traffic incident traffic incident, for providing the automobile insurance customer a prerequisite number of steps that must be followed following any incident before being able to use the deductible shield automobile deductible certificate program. these steps require the customer to contact the original insurance provider which will appraise and approve the repair costs of the customers vehicle. after the original insurance provider establishes the cost of the customers automobile deductible fee then the deductible shield automobile deductible certificate program can be used, vertically connected to said Insurance Requirements;
the deductible shield coverage the deductible shield coverage, for providing the deductible shield automobile deductible certificate program customer a list of participating licensed auto body repair shops in order fully repair the customers vehicle and allow the deductible shield automobile deductible certificate program to absorb the cost of the customers original automobile insurance's deductible fee, vertically connected to said Traffic Incident; and
an automobile repair automobile repair, for providing the deductible shield automobile deductible certificate program customer the guarantee that the deductible shield will verify that the vehicle has been fully repaired by a participating licensed auto body repair shop that honors the deductible shield automobile deductible certificate program. once the repairs have been fully verified then the repaired vehicle will be released to the customer, vertically connected to said The Deductible Shield Coverage.
